(19) United States
(12) Patent Application Publication
(10) Pub. No.: US 2006/0148554 A1
(43) Pub. Date: Jul. 6, 2006

(54) Wagering game with altered payline

(75) Inventors: Jeremy M. Hornik, Chicago, IL (US); Joel R. Jaffe, Glenview, IL (US); Dion K. Aoki, Henderson, NV (US); James J. Poole, Buckinghamshire (GB); Alfred Thomas, Las Vegas, NV (US)

Correspondence Address: JENKENS & GILCHRIST, P.C., 225 WEST WASHINGTON, SUITE 2600, CHICAGO, IL, 60606, US

(73) Assignee: WMS Gaming Inc.

(21) Appl. No.: 11/312,307

(22) Filed: Dec. 20, 2005

Related U.S. Application Data
(60) Provisional application No. 60/641,580, filed on Jan. 5, 2005.

(51) Int. Cl. A63F 13/00

(52) U.S. Cl. 463/20; 463/16; 463/21; 463/25

(57) ABSTRACT

A method of conducting a wagering game includes determining a randomly-selected outcome in response to receiving a wager input from a player. The randomly-selected outcome is selected from a plurality of outcomes that includes at least one winning outcome. Each of the plurality of outcomes is represented via a plurality of symbols arranged in a plurality of columns. The method further includes displaying the randomly-selected outcome. A prize is awarded if a symbol combination is aligned along an active payline to indicate the winning outcome. The symbol combination includes a number of symbols that is less than the number of columns.

### RELATED APPLICATIONS

This application is related to and claims priority to U.S. Provisional Patent Application Ser. No. 60/641,580 filed Jan. 5, 2005, titled “Wagering Game With Altered Payline,” which is incorporated herein in its entirety.

### FIELD OF THE INVENTION

The present invention relates generally to gaming terminals for playing a wagering game and, more particularly, to a gaming terminal having an altered payline for a set of reels that is less than the maximum set of reels.

### BACKGROUND OF THE INVENTION

Gaming machines, such as slot machines, video poker machines, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines.

Consequently, shrewd operators strive to employ the most entertaining and exciting machines available because such machines attract frequent play and, hence, increase profitability to the operator. In the competitive gaming machine industry, there is a continuing need for gaming machine manufacturers to produce new types of games, or enhancements to existing games, which will attract frequent play by enhancing the entertainment value and excitement associated with the game.

Players select one or more paylines when placing a wager during a wagering game. In general, a payline is a line on a slot machine window on which symbols from each reel must line up. Most slot machines have anywhere between one and fifteen paylines. One problem associated with current paylines is that they are limited to reel combinations that require the use of all the reels. By default, then, the number of available paylines cannot exceed the number of all-reel combinations. Providing additional paylines that are a subset of traditional all-reel paylines can increase the technical, entertainment, and excitement value associated with the wagering game.

Thus, there is a need to increase the number of paylines for a wagering game. The present invention fulfills this and other needs.

### SUMMARY OF THE INVENTION

A method of conducting a wagering game includes determining a randomly-selected outcome in response to receiving a wager input from a player. The randomly-selected outcome is selected from a plurality of outcomes that includes at least one winning outcome. Each of the plurality of outcomes is represented via a plurality of symbols arranged in a plurality of columns. The method further includes displaying the randomly-selected outcome. A prize is awarded if a symbol combination is aligned along an active payline to indicate the winning outcome. The symbol combination includes a number of symbols that is less than the number of columns.

In another aspect of the present invention, a method of conducting a wagering game on a gaming system includes accepting a primary wager input and a secondary wager input for a wagering game on a gaming system. In response to the primary wager input, a primary randomly-selected outcome is selected for the wagering game from a plurality of outcomes. Each of the plurality of outcomes is represented via a plurality of symbols arranged in a plurality of columns. In response to the secondary wager input, a secondary randomly-selected outcome is selected from the plurality of outcomes for the wagering game. The method further includes aligning a first symbol combination along a primary active payline for indicating the primary randomly-selected outcome and aligning a second symbol combination along a secondary active payline for indicating the secondary randomly-selected outcome. The first symbol combination includes a number of symbols that is equal to the number of columns and the second symbol combination includes a number of symbols that is less than the number of columns.

In an alternate aspect of the present invention, a gaming system for playing a wagering game on a gaming terminal includes a display and a controller coupled to the display. The display displays a randomly-selected outcome, which is selected from a plurality of outcomes that includes at least one winning outcome. Each of the plurality of outcomes is represented via a plurality of symbols arranged in a plurality of columns. The controller is programmed to award a prize if a symbol combination is aligned along an active payline for indicating at least one winning outcome. The symbol combination includes a number of symbols that is less than the number of columns.

The above summary of the present invention is not intended to represent each embodiment, or every aspect, of the present invention. Additional features and benefits of the present invention are apparent from the detailed description, figures, and claims set forth below.

### BRIEF DESCRIPTION OF THE FIGURES

FIG. 1 is a perspective view of a video gaming terminal according to one embodiment of the present invention.

FIG. 2 is a block diagram of the gaming terminal of FIG. 1.

FIG. 3 illustrates a game screen having paylines extending across all reels of the gaming terminal of FIG. 1.

FIG. 4 is a schematic representing paylines of various lengths.

FIG. 5 illustrates a game screen including paylines that extend continuously across some of the reels of the gaming terminal of FIG. 1, according to one embodiment of the present invention.

FIG. 6 illustrates a game screen including paylines that extend across nonadjacent reels, according to another embodiment of the present invention.

FIG. 7 illustrates a game screen that uses four reels for playing a wagering game, according to an alternative embodiment of the present invention.

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE ILLUSTRATED EMBODIMENTS

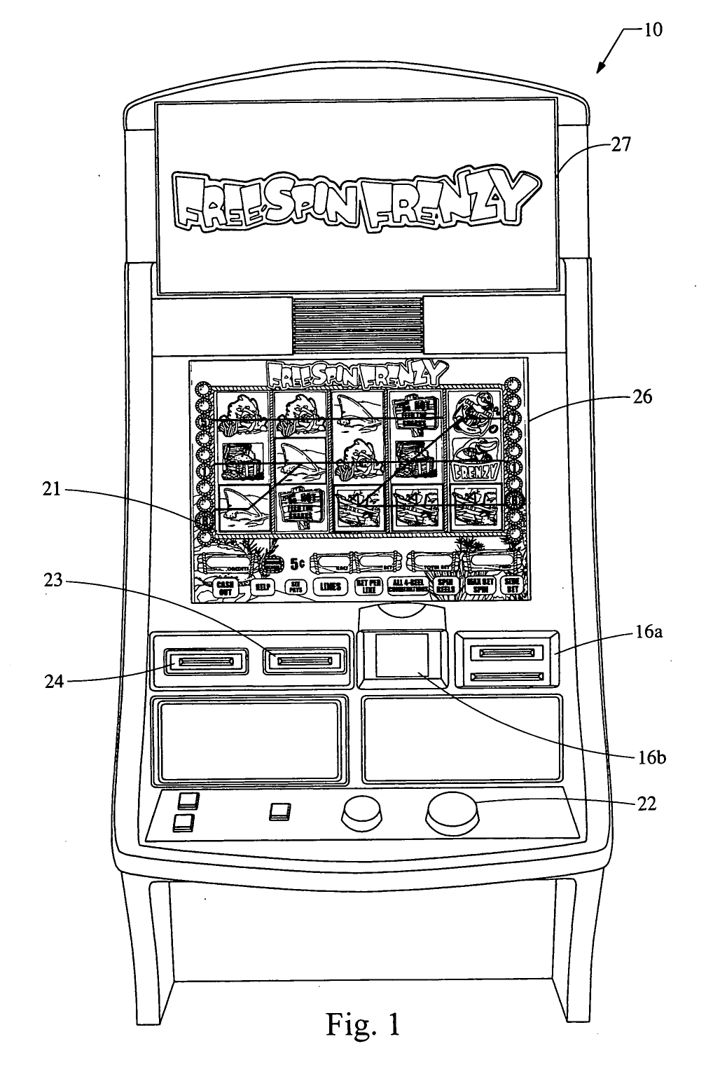

Referring to FIG. 1, a gaming terminal 10 is used in gaming establishments such as casinos. With regard to the present invention, the gaming terminal 10 may be any type of gaming terminal and may have varying structures and methods of operation. For example, the gaming terminal 10 may be a mechanical gaming terminal configured to play mechanical slots, or it may be an electromechanical or electrical gaming terminal configured to play a video casino game, such as blackjack, slots, keno, poker, etc. The current invention is focused on video or mechanical slot games.

The gaming terminal 10 includes input devices, such as a wager acceptor 16, a touch screen 21, a push-button panel 22, and a player-identification card reader 24. For output the gaming terminal 10 includes a payout mechanism 23 and a main display 26. The main display 26 displays information about the basic wagering game and, optionally, displays information about a bonus wagering game and a progressive wagering game. The gaming terminal 10 may optionally include a secondary game display 27 for displaying the bonus wagering game, or for displaying award amounts of a progressive game. While these typical components found in the gaming terminal 10 are described below, it should be understood that numerous other elements may exist and may be used in any number of combinations to create various forms of a gaming terminal.

The wager acceptor 16 may be provided in many forms, individually or in combination. The wager acceptor 16 may include a note acceptor 16a or coin slot acceptor 16b to input value to the gaming terminal 10. Or, the wager acceptor 16 may include a card-reading device for reading a card that has a recorded monetary value with which it is associated. The card may also authorize access to a central account, which can transfer money to the gaming terminal 10.

The push button panel 22 is typically offered, in addition to the touch screen 21, to provide players with an option on how to make their game selections. Alternatively, the push button panel 22 provides inputs for one aspect of operating the game, while the touch screen 21 allows for inputs needed for another aspect of operating the game.

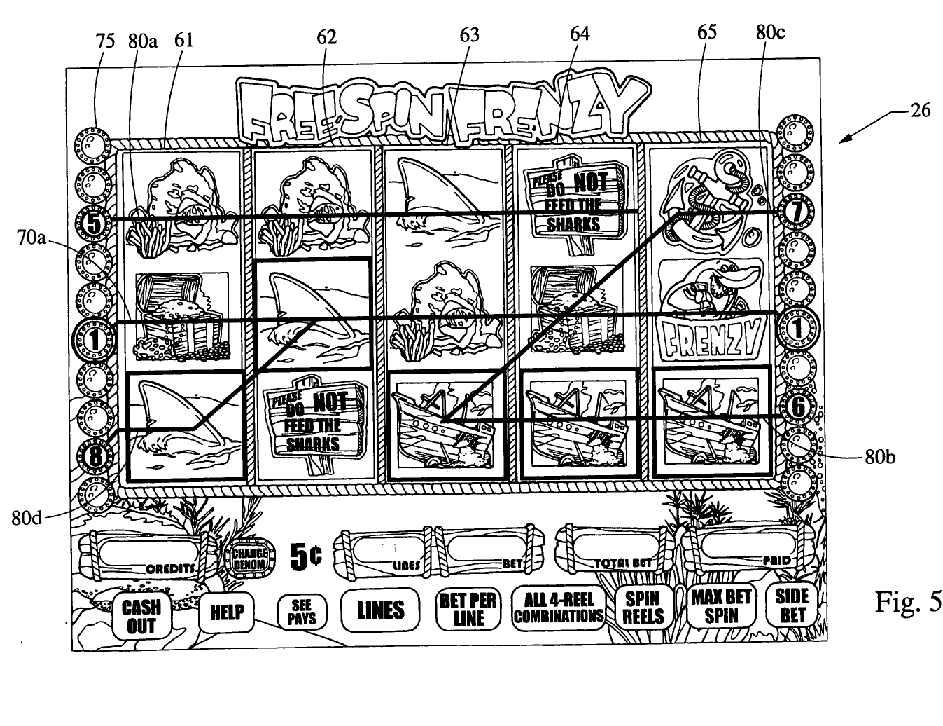

The operation of the basic wagering game is displayed to the player on the main display 26 and includes a plurality of video reels, which are shown in more detail in FIG. 5. The main display 26 can also display the bonus game associated with the basic wagering game. The main display 26 may take the form of a cathode ray tube (CRT), a high resolution LCD, a plasma display, a LED, or any other type of video display suitable for use in the gaming terminal 10. As shown, the main display 26 includes the touch screen 21 overlaying the entire monitor (or a portion thereof) to allow players to make game-related selections. Alternatively, the gaming terminal 10 may have a number of mechanical reels to display the game outcome.

The player-identification card reader 24 allows for the identification of a player by reading a card with information indicating his or her true identity. Currently, the identification is used by casinos for rewarding certain players with complimentary services or special offers. For example, a player may be enrolled in the gaming establishment's players' club and may be awarded certain complimentary services as that player collects points in his or her player-tracking account. The player inserts his or her card into the player-identification card reader 24, which allows the casino's computers to register that player's wagering at the gaming terminal 10.

A player begins play of the basic wagering game by inserting a wager input into the wager input accepter 16 of the gaming terminal 10. A player can select play by either using the touch screen 21 or the push-button panel 22. One or more outcomes of a plurality of outcomes are randomly selected in response to the wagering input by the player. One of the plurality of randomly-selected outcomes is a start-bonus outcome, which can include any variations of symbols or symbol combinations triggering a bonus game.

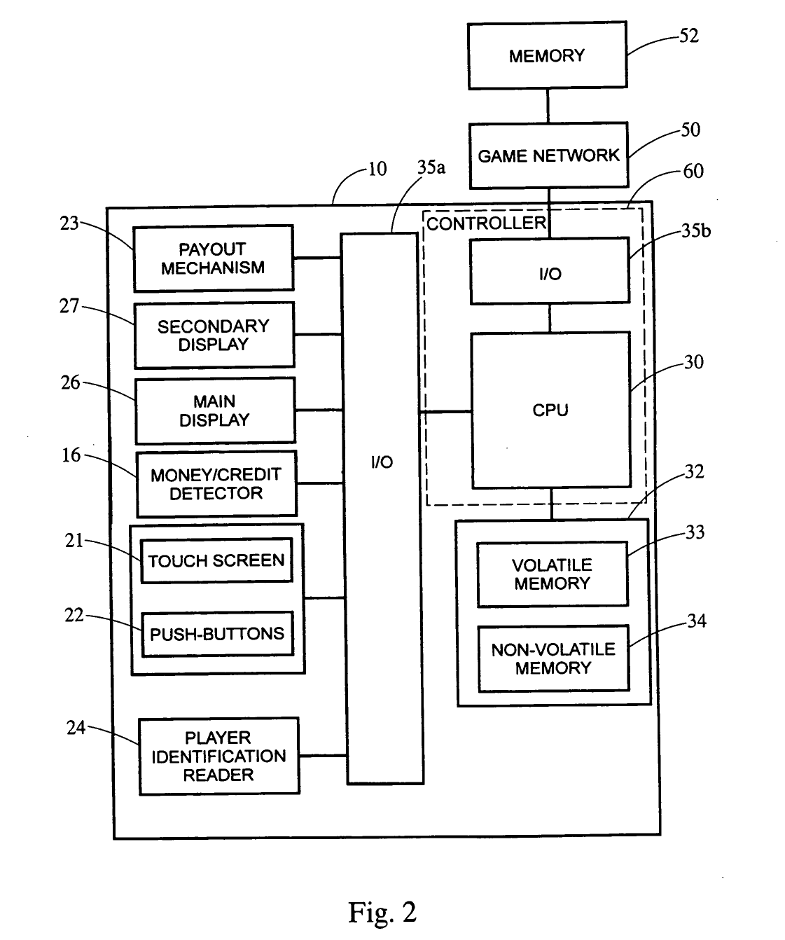

As shown in FIG. 2, the various components of the gaming terminal 10 are controlled by a central processing unit (CPU) 30, also referred to as a processor (such as a microprocessor or microcontroller). To provide the gaming functions, the CPU 30 executes one or more game programs. The CPU 30 performs the random selection of an outcome from the plurality of outcomes of the wagering game. The CPU 30 is also coupled to or includes a system memory 32. The system memory 32 may comprise a volatile memory 33 (e.g., a random-access memory (RAM)) and a non-volatile memory 34 (e.g., an EEPROM). It should be appreciated that the CPU 30 may include one or more microprocessors. Similarly, the memory 32 may include multiple RAM and multiple program memories.

Communications between the peripheral components of the gaming terminal 10 and the CPU 30 occur through input/output (I/O) circuits 35a. As such, the CPU 30 also controls and receives inputs from the peripheral components of the gaming terminal 10. Further, the CPU 30 communicates with external systems via the I/O circuits 35b. Although the I/O circuits 35 may be shown as a single block, it should be appreciated that the I/O circuits 35 may include a number of different types of I/O circuits.

The gaming terminal 10 is typically operated as part of a game control network 50 having control circuitry and one or more memory devices 52. The gaming terminal 10 often has multiple serial ports, each port dedicated to providing data to a specific host computer system that performs a specific function (e.g., accounting system, player-tracking system, progressive game control system, etc). To set up a typical serial communication hardware link to the host system, the typical RS-232 point-to-point communication protocol that is often present in the gaming terminal 10 is converted to an RS-485 (or RS-485-type) master-slave protocol so as to take advantage of some of the advantages of the RS-485 capability (e.g., multi-drop capability that allows many gaming terminals 10 to communicate with the game control network 50). To perform this function, a custom interface board may be used by the gaming terminal 10 for each communication port in the gaming terminal 10. It should be noted that the gaming terminal 10 can initially be designed to be configured for a typical RS-485 protocol, instead of the typical RS-232 protocol. Further, the gaming terminal 10 may simply be designed for an Ethernet connection to the game control network 50.

The gaming terminal 10 and associated gaming control system is capable of executing wagering games on or through a controller 60. Controller 60, as used herein, comprises any combination of hardware, software, and/or firmware that may be disposed or resident inside and/or outside of a gaming terminal 10 or like machine which may communicate with and/or control the transfer of data between the gaming terminal and a bus, another computer, processor, or device, and/or a service and/or a network. The network may include, but is not limited to a peer-to-peer, client/server, master/slave, star network, ring network, bus network, or other network architecture wherein at least one processing device (e.g., computer) is linked to at least one other processing device. The controller 60 may comprise the I/O circuits 35b and the CPU 30. In other embodiments, the CPU 30 may be housed outside of the controller 60, and a different processor may be housed within the controller 60. The controller 60, as used herein, may comprise one or more controllers. In one implementation, each gaming terminal 10 comprises, or is connected to, a controller 60 enabling each gaming terminal 10 to transmit and/or receive signals, preferably both, in a peer-to-peer arrangement. In another example, the controller 60 may be adapted to facilitate communication and/or data transfer for one or more gaming terminals 10 in a client/server or centralized arrangement. In one aspect, shown in FIG. 2, the controller 60 may connect the gaming terminal 10 via a conventional I/O port and communication path (e.g. serial, parallel, IR, RC, 10bT, etc.) to a game network 50, which may include, for example, other gaming terminals connected together in the network 50.

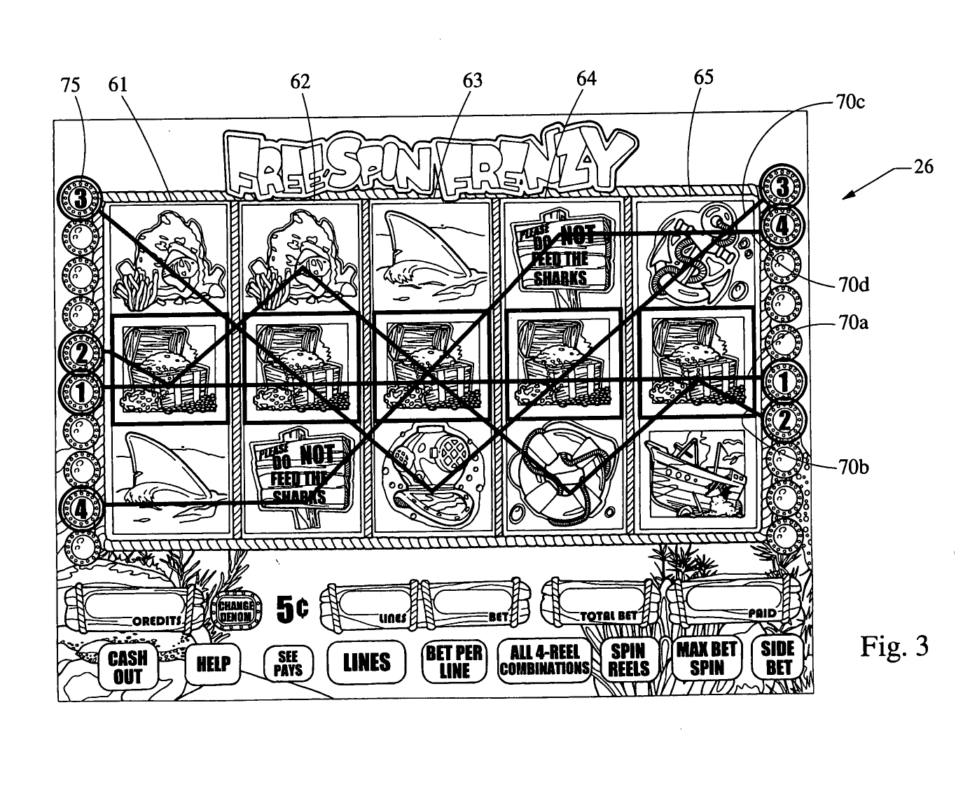

While FIGS. 3-7 describe the invention in detail, the present invention can be generally described as follows. In a current multi-reel wagering game, such as a game having a set of five reels 61-65, a player is provided with the ability to create multiple games using multiple paylines extending across the single set of reels 61-65. Accordingly, in the present invention, the player can play the standard five-reel game in the conventional sense, but has the option to wager on shorter paylines within the five reels 61-65. For example, the player can wager on paylines that extend only across a four-reel subset or a three-reel subset.

Within a base set of n reels, this novel wagering game permits the player to place wagers on different subsets of n−1, n−2, . . . n−x, where x is an integer having a value less than n. Each selection of a reel subset (e.g., a four-reel subset or a three-reel subset) activates at least one corresponding payline within the corresponding group of reels. Thus, through the selection of subsets of reels, the player is permitted to play additional paylines that are of a shorter length than the five-reel paylines of the base set of reels.

Referring to FIG. 3, the main display 26 illustrates the reels 61-65, which are also referred to as symbol-bearing reels or spinning reels, in a stopped position. During the wagering game, to achieve a winning symbol combination, one or more symbols on the reels 61-65 must be aligned along an active payline. As shown, four paylines 70a-70d have been selected by the player and are, therefore, active. All four of the paylines 70a-70d include a symbol location on each of the five reels 61-65 and are, therefore, traditional types of paylines. A payline indicator 75 is used to indicate whether a particular payline has been selected. For example, the payline indicator 75 includes a highlighting (e.g., a large bolded circle) to indicate that each one of the paylines 70a-70d has been selected, and an assigned number to indicate a respective payline to the player (e.g., the payline 70a is indicated to the player as payline 1).

The payline 70a extends across the center symbol of each one of reels 61-65. The payline 70b starts in the center symbol of the first reel 61, extends through the top symbol of the second reel 62, the center symbol of the third reel 63, and through the bottom symbol of the fourth reel 64, and ends in the center symbol of the fifth reel 65. The payline 70c starts in the top symbol of the first reel 61, extends through the center symbol of the second reel 62, the bottom symbol of the third reel 63, and through the center symbol of the fourth reel 64, and ends in the top symbol of the fifth reel 65. The payline 70d starts in the bottom symbol of the first reel 61, extends through the bottom symbol of the second reel 62, the center symbol of the third reel 63, and through the top symbol of the fourth reel 64, and ends in the top symbol of the fifth reel 65. The symbols aligned along the payline 70a are shown to indicate a winning combination, i.e., five treasure chests in a row. None of the other active paylines 70b-70d has winning combinations.

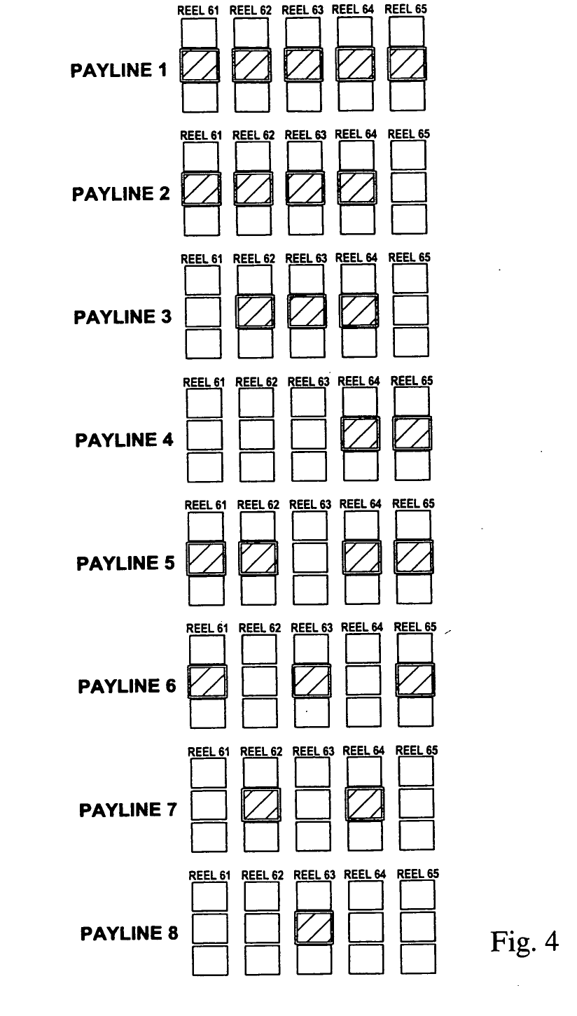

Referring now to FIG. 4, some exemplary subsets of shortened paylines are illustrated in paylines 2-8, which extend across one or more of reels 61-65. Each subset of shortened paylines 2-8 is a subset of the traditional five-reel payline 1, which is shown at the top of FIG. 4. For ease of understanding, the exemplary paylines 1-8 extend only through the center symbols of each of the reels 61-65. It is understood, then, that in other embodiments, the paylines can extend through a non-horizontal array of symbols, such as the ones shown on FIG. 3. Further, the notation numbers 1-8 used for referring to the paylines in FIG. 4, i.e., paylines “1-8,” is for exemplary purposes, and does not necessarily imply any association between paylines “1-8” and the numbers displayed in the payline indicators, such as the payline indicators 75 of FIG. 3.

As shown, payline 1 is a traditional payline that extends across all five reels. Payline 2 is a payline that uses a subset of four reels, reels 61-64. An alternative four-reel payline can be a payline that uses reels 62-65.

Payline 3 is a payline that uses a subset of three reels, reels 62-64. Other alternative three-reel paylines can use reels 61-63 and reels 63-65.

Payline 4 is a payline that uses a subset of two reels, reels 64 and 65. Other alternative two-reel paylines can use reels 61 and 62, reels 62 and 63, and reels 63 and 64.

In other embodiments, the subset of reels can include nonadjacent reels. Thus, a discontinuous (or non-continuous) payline can extend through two or more reels that are not adjacent to each other. Paylines 5-7 are some examples of non-continuous paylines. Payline 5 is a payline that uses a subset of four reels, which includes two pairs of adjacent reels (reels 61, 62, 64, and 65). Another exemplary payline that uses a subset of four reels, wherein at least one nonadjacent reel is included, can be a payline that includes adjacent reels 61, 62, and 63, and nonadjacent reel 65.

Payline 6 is a payline that uses a subset of three reels, which includes the three nonadjacent reels 61, 63, and 65. Another exemplary payline that uses a subset of three reels, wherein at least one nonadjacent reel is included, can be a payline that includes adjacent reels 61 and 62, and nonadjacent reel 65.

Payline 7 is a payline that uses a subset of two reels, which includes the two nonadjacent reels 62 and 64. Another exemplary payline that uses a subset of two reels, wherein at least one nonadjacent reel is included, can be a payline that includes reels 61 and 63.

In an alternative embodiment, the subset of reels can include a single reel. For example, payline 8 extends through the single reel 63. In contrast to a scatter symbol, which pays anywhere irrespective of paylines, a payline based on a single reel pays only in a predetermined location (i.e., respective of paylines). Further, the symbol that is aligned along the one-reel payline is included in the reel itself. In alternative embodiments any reel of the five reels can be included as a subset of the base set of reels.

Referring now to FIG. 5, the main display 26 is now shown illustrating a different combination of symbols in reels 61-65, the traditional, all-reel payline 70a, and a plurality of shortened paylines 80a-80d. For convenience, reference numerals in the “70” series denote all-reel (traditional) paylines, and reference numerals in the “80” series (and as described below, the “90” series paylines) denote shortened paylines.

Further, to help the player better distinguish between a traditional payline and a shortened payline, the payline indicator 75 for a traditional payline includes a different type of highlighting than the payline indicator 75 for a shortened payline. For example, a large bolded circle can be used to highlight the payline indicator 75 for a traditional payline and a small bolded circle can be used to highlight the payline indicator 75 for a shortened payline. Other types of distinguishing indicators (such as color) can be used as well.

Unlike FIG. 3, all-reel paylines 70b-70d are not shown as having been selected by the player. Instead, in FIG. 4, a subset of shortened paylines 80a-80d have been selected as active paylines, in addition to only one all-reel payline 70a.

The payline 80a is based on a four-reel subset that includes the top symbol of each one of the first reel 61, the second reel 62, the third reel 63, and the fourth reel 64. The payline 80b is based on a three-reel subset that includes the bottom symbol of each one of the third reel 63, the fourth reel 64, and the fifth reel 65. The payline 80c is based on a three-reel subset that includes the bottom symbol of the third reel 63, the center symbol of the fourth reel 64, and the top symbol of the fifth reel 65. The payline 80d is based on a two-reel subset that includes the bottom symbol of the first reel 61 and the center symbol of the second reel 62. As shown, two of the active paylines have winning symbol combinations. The payline 80b has a three-symbol winning combination, three wreck symbols, and payline 80d has a two-symbol winning symbol combination, two shark fin symbols.

To select any of the shorter paylines, such as paylines 80a-80d, the player can buy paylines just like the conventional all-reel payline 70a. Alternatively, the player can buy subset paylines 80a-80d at a discounted price. If, for example, the player buys all the all-reel paylines available, then the player may buy all the four-reel paylines at a reduced price. Optionally, the player may further get one or more of the three-reel paylines for free if the players buys all the four-reel paylines.

For example, in a five-reel regular game, a wager of twenty credits buys all the five-reel paylines 70 (i.e., all the all-reel paylines). An additional wager of five credits may buy two four-reel paylines 80, an additional wager of five credits may buy three three-reel paylines 80, etc. Optionally, the reduced price may be made contingent on the player wagering on a “Max Bet Spin.” The player can use such touch inputs from the touch screen 21 (FIG. 2) as the “All 4-Reel Combinations” input and the “Side Bet” input to make the appropriate selections. For example, in an alternative embodiment the “Side Bet” input can be used solely for buying subset paylines.

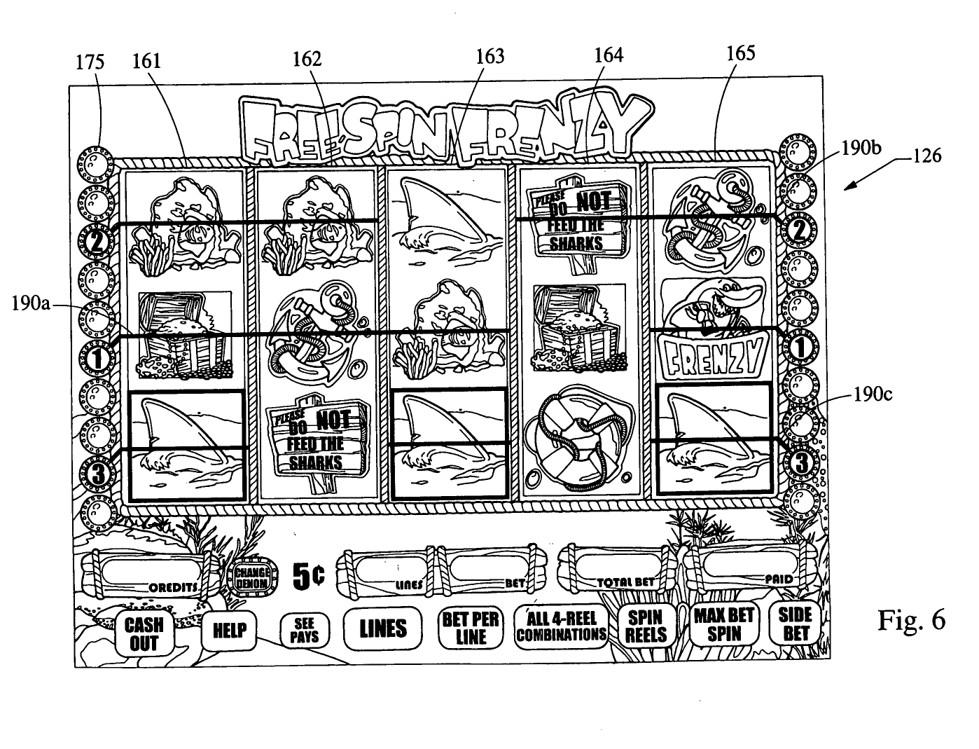

Referring to FIG. 6, according to an alternative embodiment of the present invention, a main display 126 includes a plurality of reels 161-165 and a plurality of shortened paylines 190a-190c. Unlike the traditional paylines 70 and the shortened paylines 80 in FIGS. 3 and 5, the paylines 190 are each based on a subset of the five reels 161-165, with each subset having at least one nonadjacent reel.

For example, the payline 190a includes a subset of four reels, which includes three adjacent reels 161-163 and a nonadjacent reel 165. The payline 190b includes a different subset of four reels, a first pair of adjacent reels 161 and 162 and a second pair of adjacent reels 164 and 165. However, the first pair of reels 161 and 162 is not adjacent to the second pair of reels 164 and 165. The payline 190c includes a subset of three reels, which includes reels 161, 163, and 165. Only payline 190c is shown to have a winning combination, three shark fin symbols.

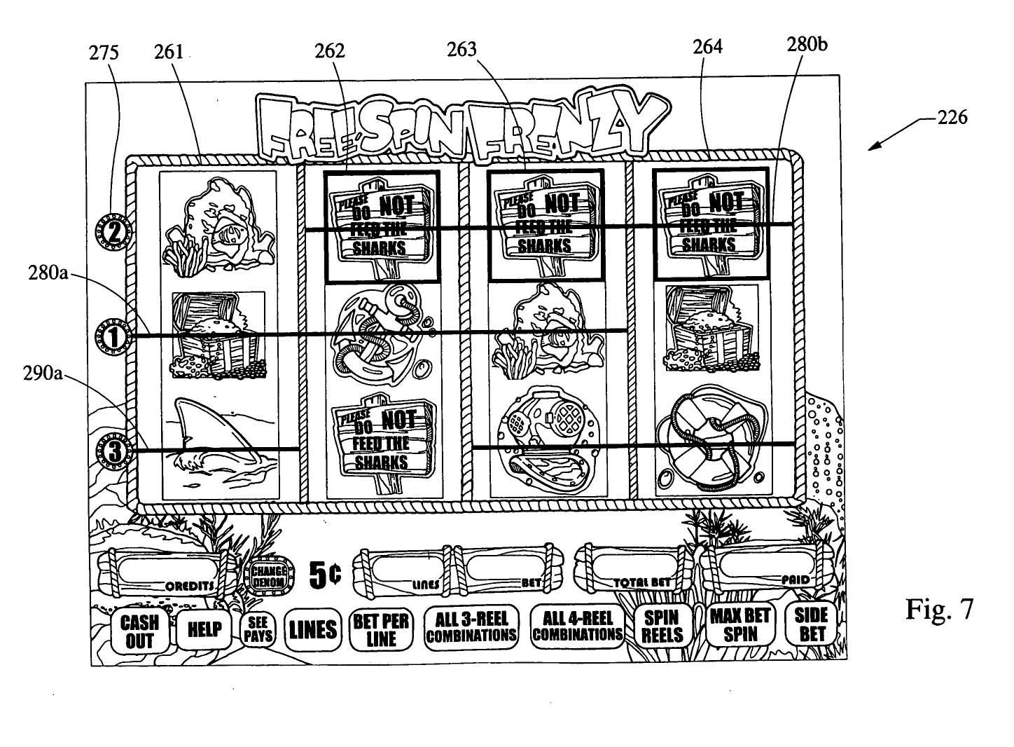

Referring to FIG. 7, in an alternative embodiment of the present invention, a main display 226 includes only four reels 261-264 and a plurality of paylines 280a, 280b, 290a. As opposed to the previous embodiments, a fifth reel has not been included.

The all-reel paylines in this embodiment are based on four-reel combinations, wherein the shortened paylines are based on three reels or less. For example, all the active paylines, paylines 280a, 280b, 290a, are shortened paylines based on three-reel combinations. The payline 280a includes a subset of three adjacent reels, reels 261-263. The payline 280b includes a different subset of three adjacent reels, reels 262-264. The payline 290a includes a subset of three reels, nonadjacent reel 261 and the pair of adjacent reels 263 and 264. The payline 280b is shown to have a winning combination, three “Please Do Not Feed The Sharks” symbols.

The shortened paylines in the previous embodiments also achieve unique payouts for the player. In one example, referring back to FIG. 4, it is assumed that a player has selected only paylines 1-3 and that a common paytable is used. If five identical advantageous symbols are aligned along payline 1, i.e., an advantageous symbol has landed in each center symbol of each one of the reels 61-65, then the player has achieved three awards. One award is awarded for the five symbols that are aligned along payline 1, one award is awarded for the four symbols that are aligned along payline 2, and one award is awarded for the three symbols that are aligned along payline 3. Thus, one advantage of using shortened paylines is that it can multiply the number of times that the player can win based on a single symbol combination aligned along one traditional active payline, such as payline 1.

In another example, still referring back to FIG. 4, it is assumed that a player has selected payline 2, payline 3, and payline 6, and that a common paytable is used. If the identical advantageous symbol lands in the center position of each one of the first reel 61, the third reel 63, and the fifth reel 65, then the player is awarded once the award for the three-symbol combination. The award is awarded because the three advantageous symbols have been aligned along payline 6, which treats the first reel 61, the third reel 63, and the fifth reel 65 as if they are adjacent to each other. In other words, the payline 6 has three advantageous symbols aligned in a row. Payline 2 has only two of the advantageous symbols, one advantageous symbol in reel 61 and one advantageous symbol in reel 63. Payline 3 has only a single advantageous symbol, which has landed in reel 63. Thus, another advantage of a shortened payline is that it can result in a winning outcome for the player when the same symbol combination along a traditional payline (or other shortened paylines) have resulted in a losing outcome.

In yet another example, still referring back to FIG. 4, the shortened paylines can wrap-around through any one of the gaming reels 61-65. For example, referring to payline 5, the payline can begin on reel 64, pass through reel 65, wrap around through reel 61, and end in reel 62. Thus, the outer reels, the first reel 61 and the second reel 65, do not necessarily act as starting and/or ending points for a shortened payline. Accordingly, a shortened payline can start and end in anyone of the reels 61-65 and not necessarily in one of the two outer reels 61, 65. Payline 3, for example, shows that a shortened payline can start in reel 62 (in a left-to-right configuration) or in reel 64 (in a right-to-left configuration), and does not necessarily start in reel 61 or in reel 65.

The above-described embodiments have been described, in general, using a conventional method of winning symbol combinations being read from left-to-right. For, example, each symbol of a winning combination must be aligned along an active payline sequentially from left to right in order to win. In alternative embodiments, a method of reading symbol combinations from right-to-left can be used with the shortened paylines. Thus, a plurality of winning symbols can also appear sequentially from right-to-left along an active payline.

As is known in the art, a paytable is located somewhere on the gaming terminal 10 and shows the player different symbol sequences that are required for a win along an active payline. The above-described embodiments have assumed a common paytable for all conventional and shortened paylines. Alternatively, different paytables could be applied to shortened paylines. For example, a three-symbol winning combination could pay “X” credits if aligned along a traditional payline, but may pay “Y” credits is aligned along a shortened payline, wherein “X”>“Y”, or “X”<“Y”.

While the invention is susceptible to various modifications and alternative forms, specific embodiments thereof have been shown by way of example in the drawings and herein described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

What at is claimed is:

1. A method of conducting a wagering game, comprising:
determining a randomly-selected outcome in response to receiving a wager input from a player, said randomly-selected outcome being selected from a plurality of outcomes including at least one winning outcome, each of said plurality of outcomes being represented via a plurality of symbols arranged in a plurality of columns;
displaying said randomly-selected outcome; and
awarding a prize if a symbol combination is aligned along an active payline for indicating said at least one winning outcome, said symbol combination including a number of symbols that is less than said number of columns.

2. The method of claim 1, wherein said active payline is one from a group consisting of a one-reel payline, a two-reel payline, a three-reel payline, and a four-reel payline, said plurality of symbol-bearing reels including at least five reels.

3. The method of claim 1, wherein said active payline extends across adjacent reels for said active payline.

4. The method of claim 1, wherein two consecutive symbols on said active payline are located on non-adjacent reels.

5. The method of claim 1, further comprising selecting said active payline via a player input.

6. The method of claim 1, further comprising providing an all-reel payline that includes symbols on all of said reels, said randomly-selected outcome also being indicated by said all-reel payline.

7. The method of claim 6, wherein said all-reel payline is paid for by said wager input, and further comprising selecting said active payline in response to receiving a side wager input.

8. The method of claim 7, wherein said side wager input is less than said wager input.

9. The method of claim 1, further comprising selecting said active payline in response to receiving said wager input.

10. The method of claim 1, wherein said active payline is a plurality of paylines, said method further comprising selecting a predetermined combination of paylines from said plurality of paylines in response to receiving a side wager input, said combination of paylines being based on a combination of reels selected from a group consisting of one reel, two reels, three reels, and four reels, said plurality of reels including at least five reels.

11. The method of claim 1, wherein a starting point of said active payline is located on an inner reel of said symbol-bearing reels, said inner reel being located between two of said symbol-bearing reels.

12. The method of claim 1, wherein said active payline wraps around from one outer reel of said symbol-bearing reels to another outer reel of said symbol-bearing reels, each of said outer reel and said another outer reel being located next to only one reel of said symbol-bearing reels.

13. A method of conducting a wagering game on a gaming system, comprising:
accepting a primary wager input and a secondary wager input for a wagering game on a gaming system;
in response to said primary wager input, selecting a primary randomly-selected outcome for said wagering game, the primary randomly-selected outcome being selected from a plurality of outcomes, each of said plurality of outcomes being represented via a plurality of symbols arranged in a plurality of columns;
in response to said secondary wager input, selecting a secondary randomly-selected outcome from said plurality of outcomes for said wagering game;
aligning a first symbol combination along a primary active payline for indicating said primary randomly-selected outcome, the first symbol combination including a number of symbols that is equal to said number of columns; and
aligning a second symbol combination along a secondary active payline for indicating said secondary randomly-selected outcome, said second symbol combination including a number of symbols that is less than said number of columns.

14. The method of claim 13, further comprising providing an award according to a common paytable if either one of said primary outcome and said secondary outcome is a winning outcome.

15. The method of claim 13, further comprising providing an award according to a first paytable for said primary outcome and an award according to a second paytable for said secondary outcome.

16. The method of claim 13, further comprising activating said secondary active payline in response to said secondary wager input.

17. The method of claim 13, wherein said gaming system includes a set of spinning reels having five reels, said secondary active payline extending at least across three reels.

18. The method of claim 13, wherein said primary active payline is a plurality of primary active paylines and said secondary active payline is a plurality of secondary active paylines, said secondary wager input having a reduced wagering amount as compared to a wagering amount for said primary wagering input when all of said primary paylines have been activated.

19. The method of claim 18, further comprising including in said plurality of secondary active paylines all paylines possible based on a subset of reels selected from a group consisting of one reel, two reels, three reels, and four reels.

20. A gaming system for playing a wagering game on a gaming terminal, comprising:
a display on said gaming terminal for displaying a randomly-selected outcome, said randomly-selected outcome being selected from a plurality of outcomes including at least one winning outcome, each of said plurality of outcomes being represented via a plurality of symbols arranged in a plurality of columns; and
a controller coupled to said display and programmed to award a prize if a symbol combination is aligned along an active payline for indicating said at least one winning outcome, said symbol combination including a number of symbols that is less than said number of columns.

21. The gaming system of claim 20, wherein said active payline extends only across adjacent reels of a plurality of reels.

22. The gaming system of claim 20, wherein said active payline extends across nonadjacent reels of a plurality of reels.

23. The gaming system of claim 20, further comprising a player input device for selecting said active payline, said player input device being coupled to said controller.

24. The gaming system of claim 20, further comprising a plurality of mechanical reels.

25. The gaming system of claim 20, further comprising a plurality of video reels.

26. The gaming system of claim 20, wherein said controller is further programmed to determine said randomly-selected outcome.

27. The gaming system of claim 20, wherein said controller is located within said gaming terminal.
